(19) United States
(12) Patent Application Publication
(10) Pub. No.: US 2026/0216746 A1
(43) Pub. Date: Jul. 30, 2026

(54) SPRAY GUN CONVERESION ADAPTER, SPRAY GUN AND CONVERSION PROCESS

(71) Applicant: 3M INNOVATIVE PROPERTIES COMPANY, St. Paul, MN (US)

(72) Inventors: Bryan J. Hayward, St. Paul, MN (US); Ryan D. Erickson, Roseville, MN (US)

(21) Appl. No.: 19/145,277

(22) PCT Filed: Jan. 4, 2024
(86) PCT No.: PCT/IB2024/050061

§ 371 Date: Jul. 2, 2025

(30) Foreign Application Priority Data
Jan. 5, 2023 (GB) 2300129.0

(51) Int. Cl. B05B 15/00; B05B 7/24

(52) U.S. Cl. CPC B05B 15/00; B05B 7/2424; B05B 7/2478

(57) ABSTRACT

Adapter (2) for converting a hand-triggered paint spray gun into an automatically-triggerable paint spray gun. The hand-triggered spray gun comprises a gun body (180) having a nozzle through which liquid paint can be sprayed, a sealable air duct for conducting pressurized air towards the nozzle for atomization of the paint, and a counter surface for sealing the air duct. The adapter (2) comprises—connecting means (200) for attaching the adapter (2) to the gun body (180); —an energy supply connector (210, 220) through which the adapter can receive mechanical or electrical energy; —a poppet actuator (230) that can be actuated automatically using mechanical or electrical energy received through the energy supply connector (210, 220); —a poppet (301), connected to the poppet actuator (230) such that actuating the poppet actuator (230) moves the poppet between a sealed position and an open position. After attaching the adapter (2) to the gun body (180), in the sealed position the poppet (301) cooperates with the counter surface such as to block compressed air from entering the air duct, and in the open position the poppet cooperates with the counter surface such as to allow compressed air to enter the air duct. The poppet (301) comprises a sealing surface for sealingly contacting, when the poppet is in the sealed position, the counter surface of the air duct such as to block compressed air from entering the air duct.

This disclosure relates to paint spray guns and to adapters and processes to convert manually-triggered into automatically-triggered paint spray guns.

Paint spray guns can generally be divided into two distinct categories: manual and automatic. Manually-operated paint spray guns are typically used by a trained human painter while automatically-operated paint spray guns are used in conjunction with some form of automated device or robot. The European patent application EP 1 243 341 A1 relates to an automatic spray gun for mounting on a robot as used, for example, in the automotive industry for painting the chassis of motor vehicles.

Spray guns of these two types sometimes have identical nozzles and aircap components but are different in most other aspects. Most manually-operated paint spray guns, for example, have a trigger allowing a person to manually control the spray volume. When the operator pulls the trigger against the force of a spring, a needle in the body of the gun is retracted from the nozzle, which allows more paint to pass through the nozzle. In contrast, the needle in automatically-operated paint spray guns, e.g. mounted on a robot arm, is retracted for example pneumatically using pressurized air under control of a computer, and no trigger is required.

As more automotive repair shops transition from manual to automatic paint spraying, some shops may wish to use a manual spray gun (i.e. a manually-triggered paint spray gun) with only few modifications as an automatic spray gun (i.e. an automatically-triggerable paint spray gun), e.g. by mounting it on a robot arm and by providing means to retract and advance the spray gun needle in some automated manner. The Chinese utility model CN 215278017 U relates to a manual spray gun multi-control device, in particular to a multi-control device capable of changing manual spray guns into automatic spray guns and capable of being synchronized. It mentions a device which can convert a manual spray gun into an automatic spray gun and can control multiple spray guns synchronously. A two-way air cylinder is connected to the side of the back of the multi-gun holder near the needle, and the piston rod of the two-way cylinder is fixedly connected with a needle pick.

Precise control of the beginning and the end of a spraying operation is desirable in order to save time, minimize waste of paint (such as “overspray”), minimize the use of pressurized air, reduce the risk of hazards, minimize noise, and/or minimize environmental contamination, e.g. contamination of a robot that may position and trigger the spray gun, of a spray cabin, etc. For precise control of an automatically-triggerable spray gun converted from a hand-triggered spray gun it is not only important to control the beginning and end of the flow of paint through the nozzle, but also to control the flow of air for atomizing the paint as it exits the nozzle. Advantageously this “atomizing air” begins to flow at the time when the first paint exits the nozzle, or even slightly before that. It is also desirable that no atomizing air flows when no paint exits the nozzle anymore, at least for reasons of cost and the avoidance of noise and of contamination of the workpiece. It may be further desired that a dedicated mechanism exists for controlling atomizing air flow in an automatically-triggerable spray gun converted from a hand-triggered spray gun. In certain scenarios it may be desired that an atomizing air control mechanism exists independently from a mechanism for controlling the position of the needle—and hence the flow of paint—in an automatically-triggerable spray gun converted from a hand-triggered spray gun.

It is thus desirable to provide an automated atomizing air control mechanism for converting a hand-triggered paint spray gun into an automatically-triggerable paint spray gun.

The present disclosure attempts to address some of these needs by providing, in a first aspect, an adapter for converting a hand-triggered paint spray gun into an automatically-triggerable paint spray gun, wherein the hand-triggered spray gun comprises a gun body comprising a nozzle through which liquid paint can be sprayed, a sealable air duct for conducting pressurized air towards the nozzle for atomization of the paint, and a counter surface for sealing the air duct; the adapter comprising
connecting means for attaching the adapter to the gun body;
an energy supply connector through which the adapter can receive mechanical or electrical energy;
a poppet actuator that can be actuated automatically using mechanical or electrical energy received through the energy supply connector,
a poppet, connected to the poppet actuator such that actuating the poppet actuator moves the poppet between a sealed position and an open position,
   wherein, after attaching the adapter to the gun body, in the sealed position the poppet cooperates with the counter surface such as to block compressed air from entering the air duct, and wherein in the open position the poppet cooperates with the counter surface such as to allow compressed air to enter the air duct,
   wherein the poppet comprises a sealing surface for sealingly contacting, when the poppet is in the sealed position, the counter surface of the air duct such as to block compressed air from entering the air duct.

The poppet, when brought into its sealed position by the automatically-actuated poppet actuator, is adapted to seal the atomizing air duct by virtue of its sealing surface which, after attaching the adapter to the gun body, sealingly contacts the counter surface in the gun body such as to block the flow of atomizing air. The adapter can thereby control the flow of atomizing air in the automatically-triggerable spray gun. The poppet can be brought into its sealed position and into its open position in an automatic manner, through the automatically-actuatable poppet actuator, which allows precise control of the beginning and the end of a spraying operation.

For enhanced automation it is desirable to avoid a manual step of a human operator pulling the trigger of a spray gun and thereby opening the atomizing air duct in order to start spraying. By using an adapter according to the present disclosure this manual step can be automated by replacing the trigger with a poppet actuator mechanism that may be actuated under control of a digital processor, e.g. a processor of a computer. In an automatically-triggerable spray gun system, for example, the processor issues a digital signal that causes a solenoid valve to open a supply of mechanical energy, such as pressurized air, into the adapter to the poppet actuator which in turn moves the poppet into its open position whereby the atomizing air starts flowing and—synchronously or following a separate activation of the flow of paint—the spray gun starts spraying. When spraying should stop, the processor issues a further digital signal that causes the solenoid valve to close and interrupt the flow of energy into the adapter to the poppet actuator, so that a spring urges the poppet into its sealed position and thereby stops the flow of atomizing air. The flow of paint may be stopped by the same signal or via a separate mechanism.

Under control of the processor the flow of atomizing air can be controlled to a higher degree of precision and more rapidly than under control of a human operator. This may help accelerate the paint spray process, e.g. when the spray gun is mounted on a robot which can position the spray gun faster than a human operator can.

The adapter of the present patent application is advantageous in that it allows the gun body and other elements of compatible hand-triggered spray guns to be used both in manual and in automatic operations. This makes the spray gun more versatile. Also, a vehicle paint shop will not need to own and operate two types of spray guns (manual and automatic), but just the manual type, which can be converted into an automatic spray gun by removing certain elements and inserting the adapter, and which can be converted back to a manual spray gun by removing the adapter and re-mounting certain elements.

In general, every spray gun requires a user to setup proper air pressure, shaping air balance, and paint flow for a specific spray job via a series of valve adjustments. These are commonly referred to as “spray gun settings”. It is common for each spray gun model to have different optimal settings for a spray job. Where an operator changes from a manual spray gun to an automatic spray gun, these spray guns are usually of different types and models, so that optimal settings for the automatic spray gun must be found that yield a comparable spray result in a comparable job. An inherent benefit of using the same spray gun model for both manual and automatic use is that the optimal spray gun settings for a job identified in manual use can continue to be used in automatic use.

As used herein, “paint” refers to coating materials that can be applied to a surface using a spray gun system. Such coating materials include, without limitation, paints as commonly understood, primers, base coats, lacquers, varnishes and similar paint-like materials as well as other materials such as adhesives, sealers, fillers, putties, powder coatings, blasting powders, abrasive slurries, mold release agents and foundry dressings which may be applied in atomized form.

The terms “liquid” and “liquid paint” as used herein include liquids or liquid paints as defined above in which solid particles, such as pigments or powders or granules or the like, are suspended.

As used herein, axial directions of a spray gun are directions along the spray axis of the spray gun. Generally, axial directions are also length directions of the needle of a spray gun. Most needles are of a generally cylindrical shape between their respective tips and feet and therefore axially symmetric with respect to a needle axis. Where the needle is axially symmetric, an axial direction is also a direction of the needle axis.

Axial directions of the gun body of a hand-triggered or of an automatically-triggerable spray gun are directions along the spray axis of the gun body and directions parallel thereto. A spray axis of the gun body is defined by the center of the nozzle and the direction of the jet of atomized paint exiting the nozzle when the spray gun is in use.

In certain embodiments wherein the poppet is connected to the poppet actuator such that actuating the poppet actuator moves the poppet linearly in an actuation direction between the sealed position and the open position. A linear movement facilitates a more precise control over the position of the poppet, as the position needs to be controlled in only one spatial dimension.

The linear direction of the poppet movement is thus also referred to herein as the “actuation direction”. The adapter may be attached to the gun body such that the actuation direction is an axial direction of the gun body. The poppet may have an elongated shape, its length direction defining a poppet length direction. Where the poppet is moved in its length direction, the actuation direction is also a poppet length direction. After attaching the adapter to the gun body, the poppet length direction and the actuation direction may be axial directions of the gun body.

As is generally understood in technology, a poppet- and also the poppet of the present adapter—is an element of a valve that moves to or from its seat. Such valves are often referred to as poppet valves or mushroom valves. The poppet of the present adapter opens or closes (seals) the atomizing air duct of the gun body. It cooperates with a counter surface in the gun body. The counter surface forms the seat of the valve or a portion of the seat.

In certain embodiments of the present adapter, the sealing surface has a frustoconical outer shape. The sealing surface may thus be frustoconical or comprise a frustoconical portion. Frustoconical shapes in sealing surfaces are advantageous in valves as they provide a well-defined abutment for the poppet and are straight-forward to manufacture. Also, in certain arrangements, a pressure difference pushes the poppet deeper into its sealing position and thereby helps improve the effectiveness of the sealing.

In other embodiments the sealing surface is hemispherical or comprises a hemispherical portion. A hemispherical portion can cooperate with a frustoconical counter surface advantageously in that only a small portion of the sealing surface contacts the counter surface. This may help concentrate the sealing force in a small area and thereby increase the sealing pressure. This may also help reduce the likelihood of a piece of debris (dirt, dried paint, congealed oils, etc) becoming wedged between the sealing surface and the counter surface and creating a leak path for the atomizing air.

The sealing surface, of frustoconical shape or not, may be a circumferential surface of the poppet. Where the poppet is axially symmetric about a poppet axis, the sealing surface may be a circumferential surface extending for a full 360 degree around the poppet axis, or it may be a circumferential surface extending for a fraction of 360 degrees around the poppet axis.

The shape of the sealing surface, however, is not particularly limited. The sealing surface may be, for example, a radial surface of the poppet.

In certain embodiments the poppet comprises a portion comprising an elastomeric material, also referred to herein as an “elastomeric portion”. The sealing surface may be a surface of this elastomeric portion. The mechanical properties of the elastomeric portion facilitate deformation of this portion—and of the sealing surface—when the sealing surface sealingly contacts the counter surface. The sealing surface can thus conform to any irregularities in the counter surface. This helps preventing air leaks.

The terms “hand-triggered spray gun”, “manual spray gun”, and “manually-operated spray gun” are used interchangeably in the present disclosure, unless otherwise indicated. The terms “automatically-triggerable spray gun”, “automatic spray gun”, and “automatically-operated spray gun” are also used interchangeably in the present disclosure, unless otherwise indicated.

The present disclosure relates to automatic and manual spray guns for spraying liquid paint. Therefore, the term “spray gun” refers to a liquid paint spray gun exclusively, and these terms are used synonymously herein, unless indicated otherwise.

A hand-triggered paint spray gun as referred to herein is a paint spray gun that comprises a trigger which is shaped to be mechanically actuated, e.g. pulled and released, by a human hand. A hand-triggered spray gun comprises a needle that is arranged in the gun body and can be moved in its length direction so that its tip moves towards or away from the nozzle at a front portion of the spray gun.

Pulling the trigger also opens an atomizing air valve in the gun body and thereby lets pressurized air flow through an atomizing air opening into the air duct towards the nozzle to atomize liquid paint exiting the nozzle. Manually actuating the trigger in one direction, e.g. the hand pulling the trigger, causes the atomizing air valve to open the atomizing air opening air duct and the needle tip to move away, or retract, from the nozzle, whereby the receding tip of the needle enlarges the open portion of the cross section of the nozzle opening. With actuating the trigger further, more atomizing air flows and more paint is sprayed through the enlarged opening of the nozzle. Similarly, manually actuating the trigger in the opposite direction, e.g. the hand releasing the trigger, causes the atomizing air valve to close the atomizing air opening and the air duct, and the needle tip to move, or advance, towards the nozzle, whereby the tip of the needle reduces the open portion of the cross section of the nozzle opening, so that less atomizing air flows and less paint is sprayed through the enlarged nozzle.

A hand-triggered spray gun is known, for example, from the International patent application published as WO 2018/104870 A1.

In contrast to a hand-triggered spray gun, an automatically triggerable spray gun can be triggered by a technical system. In other words, spraying liquid paint through a nozzle of an automatically triggerable spray gun and making atomizing air flow towards the nozzle can be started and stopped by a technical system. In a hand-triggered spray gun converted into an automatically-triggerable spray gun by attaching the adapter according to the present disclosure, the sealed position and the open position of the poppet (which determine the flow of atomizing air towards the nozzle) are attained by automatically actuating the poppet actuator.

Automatic actuation of the poppet actuator refers to actuation under control of an automated technical system, as opposed to actuation under direct control of a human, i.e. under direct manual or direct physical control of a human. An automated technical system for controlling actuation may be, for example, a computer, a digital processor, an electric or an electronic circuit. A trigger for hand-triggering a spray gun, as it exists on hand-triggered spray guns, is not considered an automated technical system.

Due to the automatic actuation the poppet can be moved into its sealed or into its open position, whereby the air duct can be sealed or opened, under control of an automated technical system, resulting in atomizing air flowing or not flowing, without requiring human intervention. The—previously hand-triggered—spray gun is, after connection of the adapter, an automatically-triggerable spray gun. It can now be used on automated spray systems, such as on spraying robots, in which a computer coordinates the movement, attitude and/or position of a support, e.g. a robot arm, supporting the spray gun with the position of the poppet in the gun and the amount of atomizing air flow at any time. The position of the needle of the automatically-triggerable spray gun—and thereby the paint spray rate—may also be automatically controlled and coordinated with the movement, attitude and/or position of the robot arm supporting the spray gun.

The term “robot”, as used herein, refers to all kinds of industrial machines—especially those programmable by a computer—which are capable of carrying out a complex series of actions automatically. Existing paint spray robots, such as those available from Dürr, Germany (durr.com), may only rarely be modified such as to operate a previously hand-triggered spray gun. Many multi-purpose industry robots, however, such as robots from Kuka (kuka.com), Fanuc (fanuc.eu), Yaskawa (yaskawa.com), ABB Robotics (new.abb.com), or Mitsubishi electric (mitsubishielectric.com), can generally be utilised to support automatically-triggerable paint spray guns as described herein.

A hand-triggered spray gun comprises at least a gun body which comprises at least a nozzle, a sealable air duct for conducting atomizing air, and a counter surface for sealing the air duct. The nozzle may be comprised in a nozzle assembly which may further comprise a paint inlet portion through which liquid paint can be supplied through the nozzle assembly to the nozzle. The paint inlet portion may comprise a liquid connector for connection of the nozzle assembly to an external paint reservoir, such as, for example, via a paint hose to a remote barrel of paint, or to a paint cup mounted directly on the nozzle assembly. The paint inlet portion may comprise a liquid connector for direct connection of the nozzle assembly to a paint cup connected directly to the liquid inlet portion of the nozzle assembly. A direct connection refers to a connection without intermediate tubes or hoses. A mechanical connection of a spout of a paint cup with the liquid connector, such that paint can flow from the paint cup through the spout into the paint inlet portion and further through the remainder of the nozzle assembly to the nozzle, is considered a direct connection, since no intermediate tube or hose is involved. A connection, in which a portion of the paint cup is in surface contact with a portion of the liquid connector, is generally considered a direct connection.

Hence in certain embodiments of an automatically-triggerable paint spray gun, converted from a hand-triggered spray gun by attaching an adapter according to the present disclosure, the gun body further comprises a nozzle assembly comprising the nozzle, wherein the nozzle assembly further comprises a liquid inlet portion through which a liquid paint can be supplied to the nozzle, wherein the liquid inlet portion comprises an inlet connector for direct connection of a paint cup to the liquid inlet portion, and optionally wherein the automatically-triggerable paint spray gun further comprises a paint cup for containing liquid paint, connected directly to the liquid inlet portion via the inlet connector.

An automatically-triggerable spray gun being equipped for direct connection of a paint cup may be beneficial in scenarios in which various different types of paint are supposed to be sprayed, and in which only small amounts of each type of paint is sprayed. Changing from one paint cup to another paint cup may then be quicker than disconnecting the spray gun from one remote barrel and connecting it to another remote barrel of paint. Also, paint cups can be changed with less effort and with less solvent required for cleaning than the amount of labour and solvent for cleaning connections or hoses to remote paint reservoirs. An automatically-triggerable spray gun provided with a paint inlet for direct connection of paint cups may thereby reduce cost and waste.

The gun body may further comprise a gun handle portion. The gun handle portion may facilitate handling, before conversion, of the spray gun by a human operator's hand, e.g. through its ergonomic shape.

Like in most spray guns, the gun body comprises a compressed air channel for conducting external pressurized air into the gun body. Some of that compressed air is conducted into the air duct which conducts atomizing air towards the nozzle for atomizing liquid paint exiting the nozzle.

Independent from the presence or absence of a gun handle portion, the gun body may further comprise an air cap. The air cap may be operable to direct atomizing air toward the stream of liquid paint exiting the nozzle. The air cap may be affixed to the nozzle assembly, where present. The air cap may comprise one or more shaping air outlets for directing pressurized air toward the stream of liquid paint as the liquid paint is expelled from the nozzle to assist in atomization of the liquid paint and shaping of the liquid paint jet into the desired spray pattern for a given application. The air cap may comprise one or more air horns, each air horn comprising one or more of the shaping air outlets.

In certain embodiments the gun body of a hand-triggered spray gun is formed by a nozzle assembly comprising a liquid paint inlet portion and a nozzle. In other embodiments the gun body of a hand-triggered spray gun comprises a nozzle assembly comprising a liquid paint inlet portion and a nozzle and a gun handle portion having a gun handle.

The hand-triggered paint spray gun, before its conversion into an automatically-triggerable paint spray gun, may comprise a needle for controlling the amount of liquid paint sprayed. The needle may be arranged at least partially within the gun body of the hand-triggered paint spray gun. The needle may be retractable from the nozzle of the gun such as to allow more of a liquid paint to be sprayed through the nozzle. The needle may also be advanced towards the nozzle to allow less of the liquid paint to be sprayed through the nozzle.

As used herein, the term “needle” refers to a long, thin, straight, rigid element that comprises a needle tip at one end and a needle foot at the opposed end. In use, the needle tip is arranged close to the nozzle and is shaped suitably to block the nozzle when the needle is completely advanced towards the nozzle, and to gradually open the nozzle further as the needle is gradually retracted from the nozzle. The thin, elongated shape of the needle defines an axis of the needle or, synonymously, a needle axis. The needle axis, as used herein, is a line through the needle tip which extends in the length direction of the needle. The needle may be axially symmetric with respect to its needle axis.

The needle foot is comprised in a needle at an end portion of the needle, opposite to the needle tip. In certain embodiments the needle foot has the shape of a cylinder. The axis of the cylinder is the axis of the needle. A cylindrical needle foot comprises a face surface, i.e. a surface of the needle foot whose surface normal is oriented parallel to the needle axis. The needle foot may have other shapes, such as, for example, a hemispherical shape or a recessed shape.

In certain embodiments, the needle foot may have the shape of a nailhead. In a nailhead shape, the radial extension of the needle foot is larger than the radial extension of the needle. Where the needle is of cylindrical shape, the diameter of the needle foot is larger than the diameter of the needle.

The hand-triggered paint spray gun, before its conversion into an automatically-triggerable paint spray gun, comprises a nozzle, similar to the nozzle described in WO 2018/104870 A1. The term “nozzle” as used herein refers to an opening in a front surface of a paint spray gun through which liquid paint is expelled.

A nozzle of an automatically-triggered or of a hand-triggered paint spray gun can be gradually opened and gradually closed by virtue of positioning of the needle relative to the nozzle. When the needle is advanced towards the nozzle, the needle tip obstructs the nozzle partially or fully and thereby causes less paint or no paint to be sprayed. When the needle is retracted from the nozzle, the needle tip obstructs the nozzle less or not at all, and thereby causes more paint to be sprayed through the nozzle.

For attaching the adapter to the spray gun body, the adapter comprises connecting means.

The connecting means may be, or may comprise, for example, a thread. The thread may interact, for example, with a compatible thread or a compatible bolt on the spray gun body or with a separate bolt or threaded pin for attachment of the adapter to the gun body. This may facilitate a particularly reliable attachment of the adapter to the spray gun body, helping to preserve a fixed spatial relation between them.

The connecting means may be, or may comprise, for example, a press fitting or an interference fitting. Such a press fitting or an interference fitting may be arranged on an insertion section of the adapter, wherein the insertion section may be a portion of the adapter designed for being inserted into the gun body, e.g. in an axial direction. The press fitting or interference fitting may interact with a compatible receiving counterpart on the spray gun body to attach the adapter reliably to the gun body.

The connecting means may be, or may comprise, other suitable means for attaching the adapter to the gun body, like, for example, a clip, a latch, a screw, a pin, a bayonet, a cap nut, a coupling ring, or any other suitable element.

The energy supply connector of an adapter according to the present disclosure facilitates supply of external energy to the adapter and to the spray gun body. In particular, the energy supply connector facilitates supply of external energy by which the poppet actuator can move the poppet between the sealed position and the open position.

In certain embodiments the energy supply connector is a pressurized air connector. A supply of pressurized air or of another pressurized gas is a supply of mechanical energy. Pressurized air can be used, for example in conjunction with a piston, to move the poppet. The pressurized air can automatically actuate the poppet actuator to move the poppet. Automatic actuation can be obtained, for example, by adjusting the pressure of the pressurized air under control of a computer. Automatic actuation can also be obtained by switching the pressure of the pressurized air on or off under control of a computer, such as via computer-controlled solenoid valves.

Hence, in certain embodiments of the adapter, the poppet actuator comprises a piston, connected to the poppet and movable relative to the energy supply connector using mechanical or electrical energy received through the energy supply connector, such that movement of the piston moves the poppet between the sealed position and the open position. A mechanism comprising a piston is available off the shelf and at moderate cost.

A piston, as used herein, is not limited to elements that can slide back and forth in a cylindrical chamber. Instead, it refers to any element that is moved linearly by energy received through the energy supply connector. An element which moves linearly in a solenoid and thereby moves the poppet, or an element caused to move linearly by a mechanical gear driven by an electrical motor are just two examples of a piston.

In certain other embodiments the energy supply connector is an electrical connector. It facilitates external supply of electrical energy to the adapter described herein. A supply of electricity, of voltage or current is a supply of electrical energy to the adapter. Electrical energy can be used, for example in conjunction with a motor or a pump or a solenoid comprised in the adapter, to move the poppet into the sealed or into the open position. Electrical power can automatically actuate the poppet actuator to move the poppet. Automatic actuation can be obtained by, for example, operating an electrical motor for a specific time under control of a computer, where the motor is connected to the poppet. Automatic actuation can also be obtained, for example, by switching the electrical power on or off under control of a computer, such as via computer-controlled relays or computer-controlled switches, to bring a relay into different positions. Automatic actuation can also be obtained, for example, by increasing or decreasing a voltage or a current for driving a pump under control of a computer or of analogue electronic or electric circuitry, where the pump creates a pressure difference which moves the poppet. Automatic actuation can also be obtained, for example, by increasing or decreasing a voltage or a current for driving an electromagnet or solenoid under control of a computer or of analogue electronic or electric circuitry, where the solenoid moves the poppet.

Actuation under control of a technical system can, for example, refer to the supply of mechanical or electrical energy being under control of a technical system. In certain embodiments the technical system may switch external electrical power on or off that is supplied via the energy supply connector, and the presence or absence of electrical power causes the poppet to be moved into the sealed or the open position. In other embodiments the technical system may increase or decrease voltage or current of external electrical power that is supplied via the energy supply connector, and the increased or decreased voltage or current of the electrical power causes the poppet to be moved. In other embodiments the technical system may increase or decrease the pressure of externally-supplied pressurized air that is supplied via the energy supply connector, and the increased or decreased pressure of the pressurized air causes the poppet to be moved. In other embodiments the technical system may switch the pressure of externally-supplied pressurized air that is supplied via the energy supply connector on or off, and the presence or absence of pressure of the pressurized air causes the poppet to be moved.

Alternatively, actuation under control of a technical system can, for example, refer to a constant supply of mechanical or electrical energy, where the use of the energy in the adapter for moving the poppet is under control of a technical system. In certain embodiments the technical system may cause a switch in the adapter to connect a motor or a pump or a solenoid to electrical power that is constantly externally supplied via the energy supply connector, and the electrical power causes the poppet to be moved. The technical system may adjust the connection of the motor, pump, or solenoid to the electrical power in suitable ways, such that, for example, the full externally-supplied voltage or current is provided to the motor, pump, or solenoid, which may cause the poppet to be moved into the open or the sealed position. Alternatively, the technical system may, for example, adjust the connection of the motor, pump, or solenoid to the electrical power in suitable ways, such that, for example, only a portion of the externally-supplied voltage or current is provided to the motor, pump, or solenoid, which may cause the poppet to be advanced or retracted only to a certain degree, corresponding to an incomplete, partial sealing of the air duct. Alternatively, the technical system may, for example, adjust the connection of the motor, pump, or solenoid to the electrical power in suitable ways, such that, for example, the externally-supplied voltage or current is provided to the motor, pump, or solenoid only at intervals of a certain length and frequency, which may cause the poppet to be moved stepwise.

The technical system may be comprised in a control system for a robot or an automatic spray system. The technical system may be controlled by a robot control system for controlling a robot or an automatic spray system. The technical system may be arranged in the adapter according to the present disclosure. Alternatively, it may be arranged outside of the adapter and/or remote from the adapter.

The poppet actuator of an adapter according to the present disclosure uses the energy supplied through the energy supply connector to move the poppet attached to it. The poppet actuator is actuated automatically and its actuation causes the poppet to be moved between its sealed and its open position. The poppet actuator is thus operable to move the poppet into the sealed position and/or to move the poppet into the open position. The poppet actuator may be operable to move the poppet between the sealed position and the open position.

In certain embodiments the poppet actuator can be actuated automatically using mechanical or electrical energy received through the energy supply connector such as to move the poppet into the sealed position and to tension an elastic element, e.g. a spring. The tensioned elastic element may be operable to move the poppet from the sealed position into the open position, e.g. when no energy is supplied through the energy supply connector.

In certain embodiments the poppet actuator can be actuated automatically using mechanical or electrical energy received through the energy supply connector such as to move the poppet into the open position and to tension an elastic element, e.g. a spring. The tensioned elastic element may be operable to move the poppet from the open position into the sealed position, e.g. when no energy is supplied through the energy supply connector.

In certain embodiments the poppet actuator is operable to be actuated automatically using mechanical or electrical energy received through the energy supply connector such as to move the poppet linearly in an actuation direction between a sealed position and an open position linearly in an actuation direction.

In certain embodiments the poppet actuator is a pneumatic poppet actuator in which mechanical energy, in the form of pressurized air supplied via the energy supply connector to the poppet actuator, is used to move the poppet. Movement of the poppet actuator moves the poppet and thereby closes (seals) or opens the air duct through which pressurized air is conducted towards the nozzle for atomization of the paint.

In certain embodiments the poppet actuator is an electric poppet actuator in which electrical energy, in the form of voltage and/or current supplied via the energy supply connector to the poppet actuator, is used to move the poppet between the sealed position and the open position. The poppet actuator may, for example, comprise an electromagnet which moves into a certain position when powered, and moves back, often against a spring load, into its original position when power is switched off. The movement of the electromagnet is transformed into an actuation of the poppet actuator which in turn moves the poppet.

The poppet actuator may, for example, comprise an electric pump. The electric pump may generate a certain pressure difference in a gas or in a liquid. The pressure difference moves a piston or another movable element into a certain position when the pump is powered. The element moves back, e.g. against a spring load, into its original position when the pump is switched off. The pressure difference created by the pump is thus transformed into a movement of the movable element, which is transformed into a movement of the poppet actuator and thereby the poppet.

Further to these examples any other known mechanism can be used to transform a movement of a piston or of another movable element driven by the mechanical or electrical energy supplied through the energy supply connector into an actuation of the poppet actuator and a movement of the poppet.

In hand-triggered spray guns and in automatically-triggered spray guns described herein a flow of pressurized air exits the nozzle assembly in the vicinity of the nozzle and atomizes liquid paint exiting the nozzle. This flow of “atomizing air” creates a jet of small paint droplets. For a well-defined start of a spraying operation, it is desirable that atomizing air begins to flow before paint begins to flow. This sequence is often referred to as “first air”. In hand-triggered spray guns first air can be achieved by pulling the trigger a short distance causing the atomizing air to flow without any paint flowing. Pulling the trigger further retracts the needle from the nozzle and thereby causes the paint to start flowing as well. Pulling the trigger even further opens the nozzle further and thereby increases the paint flow rate.

In automatically-triggerable spray guns, upgraded from hand-triggered spray guns by attaching an adapter according to the present disclosure, first air can be achieved by coordinating the movement of the poppet out of its sealed position towards its open position with the retraction of the needle from the nozzle and the related onset of paint flow. The coordination is advantageously done such that the poppet moves out of its sealed position—whereby some atomizing air can flow through the air duct towards the nozzle—before the needle starts to retract from the nozzle.

The needle may have its own, independent needle actuator. Alternatively, the needle may be mechanically connected to the poppet, so that a movement of the poppet can move the needle relative to the nozzle. A connection between poppet and needle can help avoid a need to establish a separate mechanism for advancing or retracting the needle independently from the poppet.

Hence in certain embodiments the adapter according to the present disclosure further comprises a needle, suitable for being arranged in the gun body such that a tip of the needle is arranged next to the nozzle such that, in use, retracting the needle from the nozzle causes more of the paint to be sprayed through the nozzle and that advancing the needle towards the nozzle causes less of the paint to be sprayed through the nozzle, wherein the needle is mechanically connected to the poppet such that movement of the poppet between the open position and the sealed position causes a movement of the needle.

Once the adapter is connected properly to the gun body, a movement of the poppet from its sealed position into its open position causes a movement of the needle away from the nozzle. This opens the nozzle and paint can flow through the nozzle. Similarly, a movement of the poppet from its open position into its sealed position causes a movement of the needle towards the nozzle such that the tip of the needle blocks the opening of the nozzle. This closes the nozzle and stops the flow of paint through the nozzle.

The connection of the needle to the poppet may be designed such that a foot of the needle is attached to the poppet, either in direct contact with the poppet or attached via an intermediate element. The sealing surface may be arranged concentrically around the portion of the poppet contacting the needle or the intermediate element. The needle diameter is then chosen such that a sufficient amount of air can flow between the sealing surface and the counter surface into the air duct.

It is often desirable that an initial small retraction of the poppet by the poppet actuator allows flow of atomization air only, but not (yet) of paint. Only further retraction of the poppet allows flow of both atomization air and paint. Such a mechanism is referred to as “first air”. The presence of a spring in the poppet facilitates implementation of a simple and reliable “first air” mechanism: Where the adapter comprises a needle connected to the poppet as described above, the poppet may comprise a spring to exert an axial force on the needle to keep the needle pressed forward (i.e. against the nozzle, once the adapter is connected to a gun body) relative to the poppet. The needle tip thereby blocks the nozzle, while the poppet has already been retracted from its sealed position by a small distance. The minor retraction of the poppet opens the atomizing air duct in the gun body to some degree so that atomizing air can flow while paint is still blocked. Further retraction of the poppet then results in the needle being retracted from the nozzle, which unblocks the nozzle and lets paint flow through the nozzle.

Hence, in certain embodiments the adapter further comprises an elastic spring, wherein the needle is elongated to define a needle length direction, wherein the spring is arranged between a support portion of the poppet and a portion of the needle such as to facilitate a spring-loaded movement of the needle in the needle length direction relative to the poppet.

In certain embodiments an adapter according to the present disclosure comprises an elongated insertion section, shaped to be inserted along its length direction into the gun body of the hand-triggered paint spray gun. In certain embodiments the adapter comprises a cylindrical insertion section, shaped to be inserted along the symmetry axis of the cylindrical insertion section into the gun body of the hand-triggered paint spray gun. In other embodiments the adapter comprises an insertion section of a non-circular cross section, shaped to be inserted along the symmetry axis of the cylindrical insertion section into the gun body of the hand-triggered paint spray gun.

Generally, the gun body may comprise an adapter receptacle of a cross section that corresponds to the cross section of the insertion section. The corresponding cross sections may facilitate insertion of the insertion section into the adapter receptacle with a tight fit and hence an improved spatial adjustment of the adapter to the gun body. Where the adapter comprises an insertion section of a non-circular cross section, and where the gun body comprises an adapter receptacle of a corresponding non-circular cross section, the non-circular cross section may help prevent rotation of the adapter relative to the gun body and may thus facilitate a more reliable attachment of the adapter to the gun body.

Presence of an insertion section of the adapter is generally beneficial in that insertion of a portion of the adapter into the gun body may facilitate a more reliable attachment of the adapter to the gun body. It may also facilitate a more direct or shorter connection of the poppet actuator with the poppet which is advantageously located inside the gun body.

Generally, an insertion direction of the adapter may be a length direction of an elongated insertion section, or a symmetry axis of a cylindrical insertion section of the adapter.

The gun body of the hand-triggered paint spray gun may comprise an adapter receptacle for receiving the insertion section of the adapter. In order to create an adapter receptacle, certain components of the hand-triggered spray gun may have been removed, such as, for example, a needle adjustment spring, a needle adjustment mechanism, a needle, or a trigger. The adapter receptacle may have an elongated shape. The length of the elongated adapter receptacle may define a receptacle length direction. The adapter receptacle may have a cylindrical shape. The symmetry axis of the cylindrical adapter receptacle may define a receptacle length direction. The receptacle length direction may be parallel to, or may be collinear with, an axial direction of the spray gun body.

An adapter according to the present disclosure can be used to convert a hand-triggered spray gun into an automatically-triggerable spray gun. This disclosure therefore also provides an automatically-triggerable paint spray gun comprising
a gun body comprising a nozzle through which liquid paint can be sprayed, a sealable air duct for conducting pressurized air towards the nozzle for atomization of the paint, and a counter surface for sealing the air duct,
an adapter as described herein, attached to the gun body using the connecting means such that the sealing surface of the poppet, in the sealed position, cooperates with the counter surface such as to block compressed air from entering the air duct, and such that, in the open position, the sealing surface cooperates with the counter surface such as to allow compressed air to enter the air duct.

As stated before, such an automatically-triggerable spray gun can provide more precise control of the beginning and the end of a spraying operation and may thereby save time, minimize waste of paint, minimize the use of pressurized air, reduce the risk of hazards, minimize noise, and/or minimize environmental contamination, e.g. contamination of a robot positioning and triggering the spray gun, of a spray cabin, etc.

Where the sealing surface of the poppet is frustoconical or has a frustoconical portion, sealing is improved where the counter surface of the gun body is of a corresponding shape. A corresponding shape, i.e. a shape where the counter surface shape is the negative of the sealing surface shape, can generally improve the quality of the seal and may help to distribute forces on the seal more evenly.

Therefore, in certain embodiments of automatically-triggerable spray guns according to the present disclosure the sealing surface is frustoconical or comprises a frustoconical portion, and the counter surface has a corresponding frustoconically shaped portion for sealingly contacting the sealing surface such as to block compressed air from entering the air duct when the poppet is in the sealed position.

In other embodiments the sealing surface is hemispherical or comprises a hemispherical portion, and the counter surface has a corresponding hemispherically shaped portion for sealingly contacting the sealing surface such as to block compressed air from entering the air duct when the poppet is in the sealed position.

An improved sealing of the atomizing air duct may may be obtained if the sealing surface and the counter surface are not of a corresponding shape but have different shapes. In certain preferred embodiments the sealing surface is hemispherical or comprises a hemispherical portion, and wherein the counter surface has a frustoconically shaped portion for sealingly contacting the sealing surface such as to block compressed air from entering the air duct when the poppet is in the sealed position. This may help reduce the likelihood of a piece of debris (dirt, dried paint, congealed oils, etc) becoming wedged between the sealing surface and the counter surface and creating a leak path for the atomizing air.

The automatically-triggerable spray gun, after conversion by attaching the adapter of the present disclosure, may be better laterally balanced, smaller in size and have a slimmer lateral profile if the poppet is moved parallel to the spray axis, i.e. in a front-rear direction of the spray gun.

Therefore, in certain embodiments of the automatically-triggerable spray gun the spray gun can eject a jet of atomized paint along a spray axis, the poppet is connected to the poppet actuator such that actuating the poppet actuator moves the poppet linearly in an actuation direction between the sealed position and the open position, and wherein the adapter is arranged such that the actuation direction is parallel to the spray axis.

Preferably the poppet, after conversion, is arranged in the gun body with its length axis being collinear with the spray axis. This provides for a more axially-symmetric design of the spray gun and thereby allows the paths of compressed air to be potentially shorter.

In certain embodiments of the automatically-triggerable spray gun after conversion, the poppet is rotationally symmetric about a poppet axis, wherein the poppet axis is parallel to the actuation direction, and wherein the poppet axis is collinear with the spray axis.

Where this disclosure refers to an arrangement “behind the needle”, it refers to an arrangement below the needle foot, considering the needle tip being located above the needle foot. Where this disclosure refers to an arrangement “rearward from the needle foot”, it considers the needle tip being located forward from the needle foot, and rearward being a direction opposite to a forward direction.

Arranging the poppet actuator behind the needle may be beneficial in that it may help save space laterally and minimize the lateral profile of the automatically-triggerable spray gun. Where the poppet actuator moves the poppet and the needle, this arrangement may also allow for a coaxial movement of the poppet and the needle. A coaxial transmission of forces may allow for a simpler mechanical design.

Hence in certain embodiments an automatically-triggerable paint spray gun, upgraded from a hand-triggered spray gun by attaching an adapter according to the present disclosure, further comprises a needle, wherein the needle is elongated to define a needle length direction, wherein the needle extends rearward, in the needle length direction, from a pointed tip to a needle foot, wherein the needle is arranged in the gun body such that the tip is arranged next to the nozzle such that, in use, retracting the needle from the nozzle causes more of the paint to be sprayed through the nozzle and that advancing the needle towards the nozzle causes less of the paint to be sprayed through the nozzle, and wherein the poppet actuator is arranged rearward, in the needle length direction, from the needle foot.

A hand-triggered paint spray gun can be converted into an automatically-triggerable paint spray gun by a process which, potentially along with other steps, involves removing the existing atomizing air valve, previously moved by manually actuating the trigger, and replacing it with the automatically-triggerable poppet of the adapter of the present disclosure, and attaching the adapter to the gun body such that the poppet in its open position allows compressed air to enter the air duct, and in its sealed position, blocks compressed air from entering the air duct.

The process may also comprise removing the manual trigger which has become obsolete.

The present disclosure therefore also provides a process for converting a hand-triggered paint spray gun into an automatically triggerable paint spray gun, the process comprising
providing a hand-triggered paint spray gun comprising
   a) a gun body comprising a nozzle through which liquid paint can be sprayed, a sealable air duct for conducting pressurized air towards the nozzle for atomization of the paint, a counter surface for sealing the air duct, and an atomizing air valve for cooperating with the counter surface such as to open or seal the air duct;
   b) a trigger, mechanically connected to the atomizing air valve such that the atomizing air valve opens the air duct when the trigger is manually pulled,
providing an adapter as described herein;
removing the atomizing air valve;
attaching the adapter to the gun body using the connecting means such that the sealing surface of the poppet, in the sealed position, cooperates with the counter surface such as to block compressed air from entering the air duct, and such that, in the open position, the sealing surface cooperates with the counter surface such as to allow compressed air to enter the air duct.

This process results in an automatically-triggerable paint spray gun in which the flow of atomizing air is automatically triggered by moving the poppet between its sealed position and its open position. This movement is automatically triggered by automatically actuating the poppet actuator using the energy provided through the energy supply connector of the adapter.

The trigger ceases to have a function in the converted automatically-triggerable paint spray gun which results from the process described above. Removing the trigger may thus be advantageous in that it makes the space occupied by the trigger available, e.g. for attaching the spray gun to a robotic arm.

In certain embodiments of the process described above the process further comprises removing the trigger from the hand-triggered spray gun. The removal of the trigger may, for example, be performed before attaching the adapter to the gun body. Removal of the trigger may, for example, be performed before or after removing the atomizing air valve.

After conversion the triggering of atomization air in the automatically-triggerable spray gun is controlled solely by the adapter and its poppet actuator, so that the needle adjustment control knob is not required any more. Removing the needle adjustment control knob is advantageous because this may free up a passageway, previously occupied by the needle adjustment control knob, leading into the gun body into which passageway an insertion section of the adapter can be inserted.

Therefore, in certain embodiments of the processes described above providing a hand-triggered paint spray gun comprises providing a hand-triggered paint spray gun further comprising c) a needle adjustment control knob, and the process further comprises removing the needle adjustment control knob from the hand-triggered spray gun.

Insertion of the adapter into the gun body may be beneficial because an adapter inserted into the gun body is often easier to attach reliably to the gun body, and also because insertion into the gun body towards the counter surface of the air duct may help reduce the distance between the poppet and the poppet actuator, so that the connection between these two elements can be shorter and thereby more reliable and less costly.

Therefore, in certain embodiments of the processes described above, attaching the adapter to the gun body comprises inserting a portion of the adapter, such as an insertion section of the adapter, into the gun body.

The invention will now be described in more detail with reference to the following Figures exemplifying particular embodiments of the disclosure, wherein like reference numbers indicate like elements:

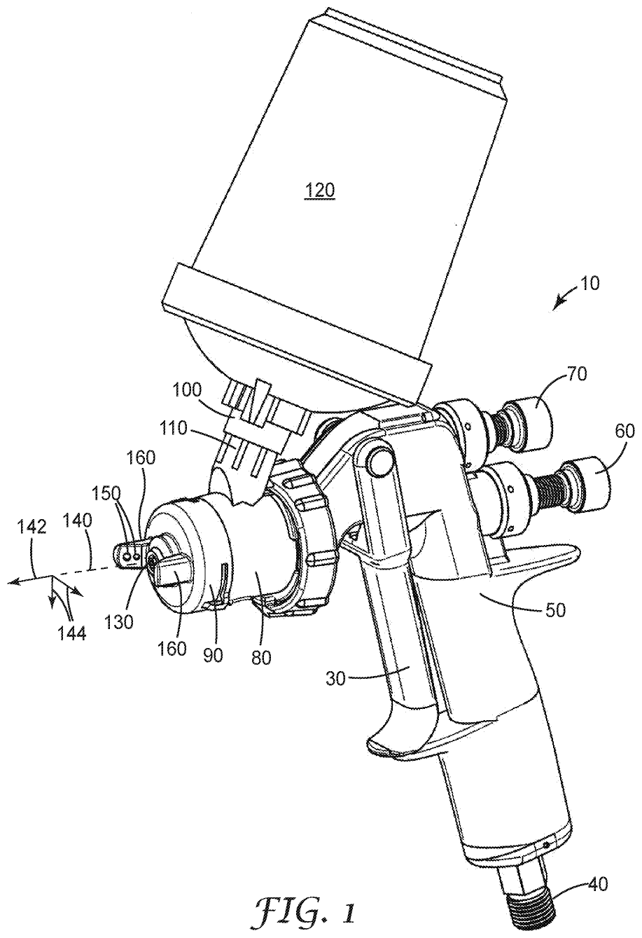

FIG. 1 Perspective view of a hand-triggered paint spray gun before conversion;

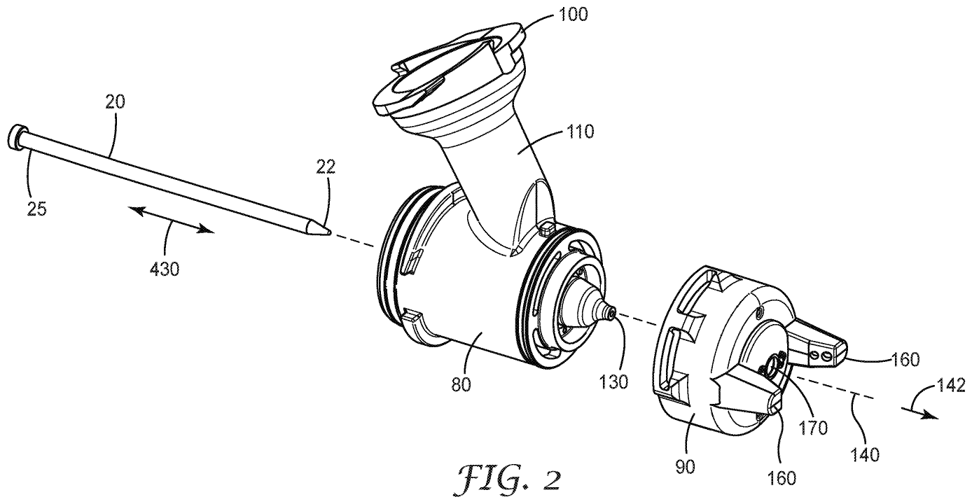

FIG. 2 Perspective exploded view of certain elements of the spray gun of FIG. 1;

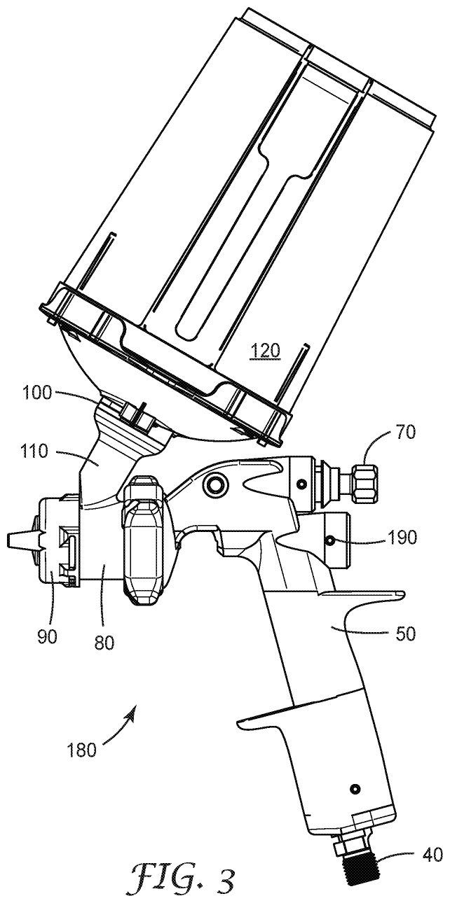

FIG. 3 Perspective view of the gun body of the spray gun of FIG. 1;

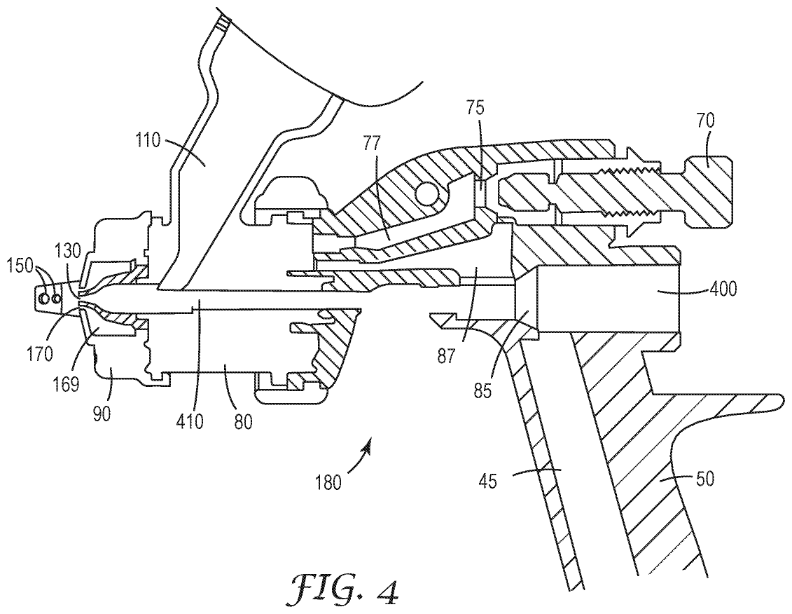

FIG. 4 Sectional view of the gun body of FIG. 3;

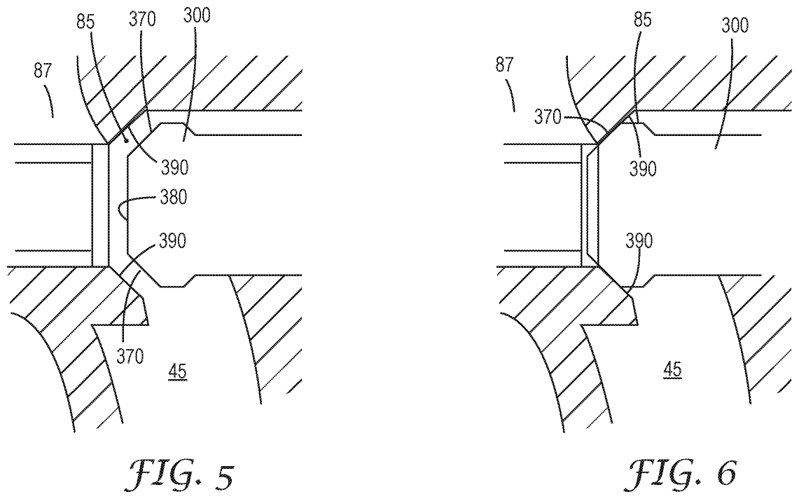

FIG. 5 Sectional view of the gun body of FIG. 3 and a poppet of an adapter according to the disclosure, in its open position;

FIG. 6 Sectional view of the gun body of FIG. 3 and the poppet of FIG. 5 in its sealed position;

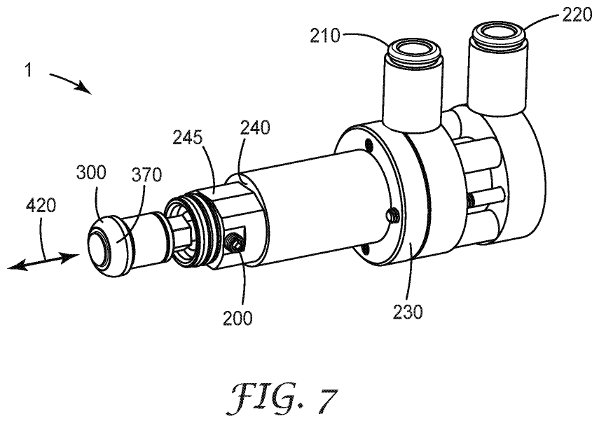

FIG. 7 Perspective view of a first adapter according to the present disclosure;

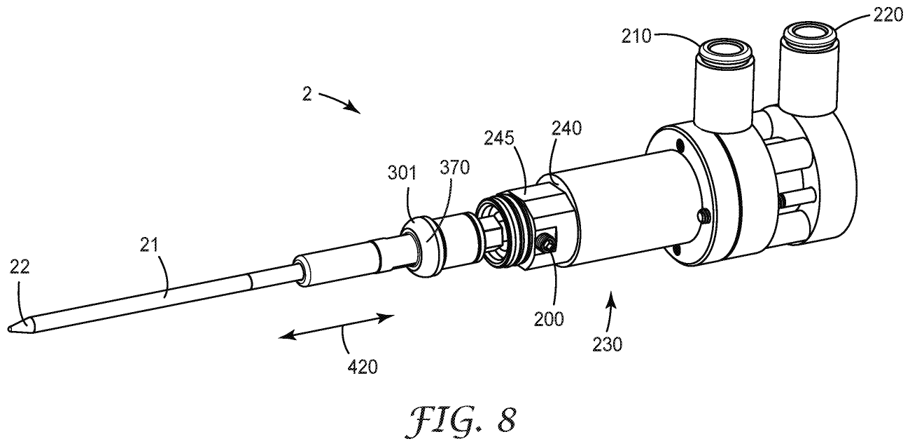

FIG. 8 Perspective view of a second adapter according to the present disclosure;

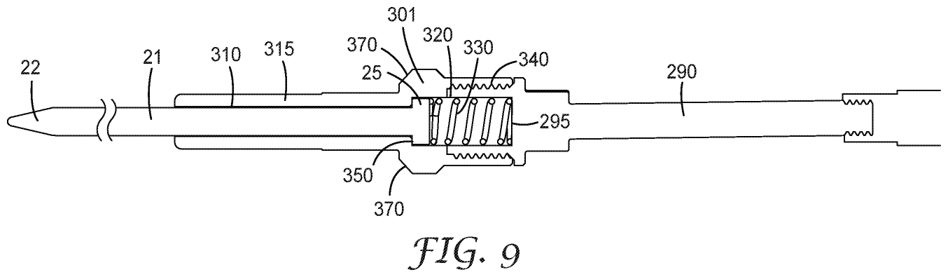

FIG. 9 Sectional view of the poppet of the second adapter of FIG. 8;

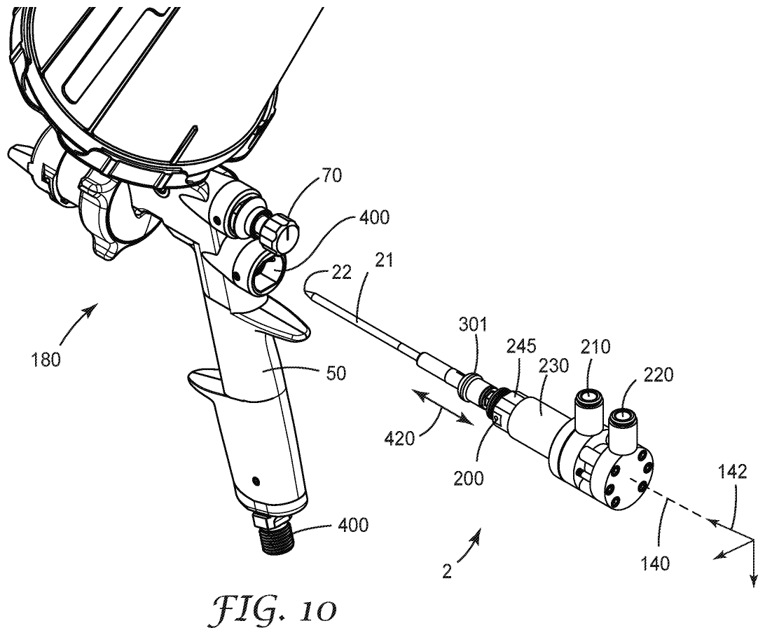

FIG. 10 Perspective view of the gun body of FIG. 3 and the second adapter of FIG. 8 before attaching the second adapter to the gun body;

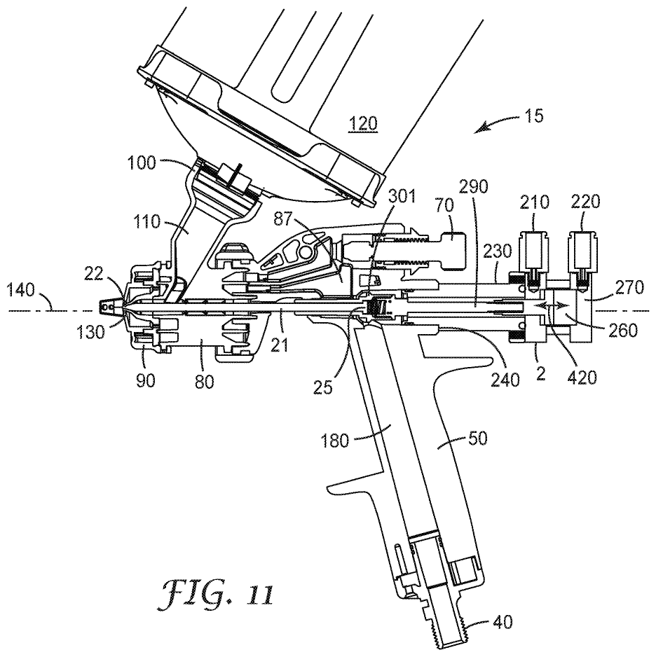

FIG. 11 Sectional view of an automatically-triggerable paint spray gun, resulting from attaching the second adapter of FIG. 8 to the gun body of FIG. 3.

FIG. 1 is a perspective view of an exemplary hand-triggered paint spray gun 10 before conversion into an automatically-triggerable spray gun via an adapter according to the present disclosure. The paint spray gun 10 comprises a gun handle portion 50, a trigger 30, an air connection 40 for an external pressurized air source, a needle 20 (not visible in FIG. 1), a needle adjustment control knob 60, a shaping air control knob 70, a spray gun nozzle assembly 80 and an air cap 90. The nozzle assembly 80 comprises a nozzle 130 through which liquid paint exits the spray gun 10 and a liquid paint connector 100, located at an ed portion of a liquid inlet portion 110, through which a liquid paint is supplied to the spray gun 10 from an external paint reservoir 120, namely a paint cup 120 mounted directly on the nozzle assembly 80 via the liquid paint connector 100.

A human operator can hold the spray gun 10 at the gun handle portion 50, manually pull the trigger 30 and thereby retract the needle 20 inside the spray gun 10 from the nozzle 130, allowing pressurized air and paint to exit the spray gun 10 at the nozzle 130 generally in a direction along a spray axis 140.

The spray axis 140 is oriented in the length direction of the needle 20, as is explained in the context of FIG. 2. The length direction of the needle 20 is also the direction of the needle movement when the needle 20 is advanced or retracted using the trigger 30. The spray axis 140 defines axial directions 142 and radial directions 144 orthogonal to the axial directions 142.

When the trigger 30 is pulled, the needle 20 is withdrawn from the nozzle 130, thereby allowing the liquid paint to pass through the nozzle 130. At the same time, pulling the trigger 30 activates the pressurized air supplied through air connection 40 to assist in liquid paint passing through the nozzle 130. Some of the air is used for atomizing the liquid paint (“atomizing air”), some of the air (“shaping air”) is used for shaping the jet of paint drops (e.g., via the air cap 90). The maximum travel of the needle 20 and the total air flow through the spray gun 10 is adjusted via the needle adjustment control knob 60.

The shaping air control knob 70 adjusts the amount of shaping air expelled through the air cap 90 affixed to the front of the nozzle assembly 80. The air cap 90 can direct pressurized air advantageously toward the jet of atomized liquid paint, e.g. via shaping air outlets 150 located on two opposed air horns 160. As the paint is expelled from the nozzle 130, atomization air expelled from the air cap 90 assists in atomization of the liquid paint and shaping of the liquid paint jet into the desired spray pattern for a given application. Within the air cap 90 or proximate the air cap 90, a center air outlet (not visible in FIG. 1) directs atomizing air around the nozzle 130 to draw the liquid paint from the nozzle 130 and atomize it, creating a fine mist of droplets.

In order to convert the hand-triggered spray gun 10 of FIG. 1 into an automatically triggerable spray gun by attaching an adapter according to the present disclosure to the gun body, certain elements of the hand-triggered spray gun 10 are removed from the hand-triggered spray gun 10, such as the trigger 30 and the needle adjustment control knob 60. What remains of the hand-triggered spray gun 10 after removal of these elements is referred to as the “gun body”, which is illustrated in FIG. 3.

FIG. 2 illustrates, in a perspective exploded view, the needle 20, the nozzle assembly 80 and the air cap 90 of the hand-triggered paint spray gun 10 of FIG. 1 in more detail. The air cap 90 is attached to the nozzle assembly 80. In an assembled state, the nozzle 130 is surrounded by the center air outlet 170 of the air cap 90. Atomizing air expelled from the center air outlet 170 atomizes the liquid paint exiting through the nozzle 130.

The liquid paint connector 100 is designed to engage with a corresponding connector of a liquid paint reservoir 120, such as the gravity-fed spray gun paint cup 120 which is shown in FIG. 1. Liquid paint from the reservoir 120 flows through the liquid inlet portion 110 to the nozzle 130 where the paint is atomized and sprayed.

The needle 20 extends in a needle length direction 430 and comprises a needle tip 22 at its forward end and a needle foot 25 at the opposite end. In this embodiment the needle foot 25 has a larger diameter than the remainder of the needle 20. In other embodiments the needle foot may have the same diameter as the remainder of the needle. As is usual, the needle 20 is arranged with its length direction 430 parallel to the spray axis 140 and extends through the gun handle portion 50 and the nozzle assembly 80 up to the nozzle 130. When the needle 20 is retracted, i.e. moved rearward away from the nozzle 130, the nozzle 130 is opened, liquid paint exits through the nozzle 130, and pressurized air is expelled through the center air outlet 170 (for atomizing the liquid paint) and through the shaping air outlets 150 (for shaping the spray pattern), creating a shaped jet of paint droplets. When the trigger 30 (shown in FIG. 1) is not pulled and fully advanced, i.e. moved forward towards the nozzle 130, an air duct (not visible in FIGS. 1 and 2) for conducting pressurized air towards the nozzle 130, specifically to the center air outlet 170, is blocked so that no atomizing air flows through the center air outlet 170. In this position of the trigger 30 the tip 22 of the needle 20 closes the nozzle 130, thereby stopping the paint flow.

FIG. 3 illustrates in a side view a gun body 180 of the hand-triggered spray gun 10 of FIG. 1. The needle 20, the trigger 30, the needle adjustment control knob 60, an atomizing air valve (not shown) and other elements have been removed from the hand-triggered spray gun 10 shown in FIG. 1. After their removal the remainder of the hand-triggered spray gun 10 forms the gun body 180.

In the preferred embodiment illustrated in FIG. 3 the gun body 180 comprises the nozzle assembly 80 with the nozzle 130 (not visible in FIG. 3), the air cap 90, the gun handle portion 50, the shaping air control knob 70, the liquid inlet portion 110 and the liquid paint connector 100, as well as the external paint reservoir 120. The needle 20 has been removed and is thus not comprised in the gun body 180.

In the embodiment of FIG. 3 the gun body 180 comprises a nozzle assembly 80 and an air cap 90, but no trigger 30. In alternative embodiments the gun body may comprise fewer elements than those of the gun body 180 of FIG. 3. The gun body may comprise a liquid inlet portion 110, but no gun handle portion 50. In a minimum configuration the gun body comprises a nozzle assembly 80 including a nozzle 130 for spraying liquid paint fed into the nozzle assembly. In a minimum configuration the nozzle assembly 80 may comprise a liquid inlet portion 110 having a liquid paint connector 100 for connection to an external paint reservoir 120 from which liquid paint can be supplied to the nozzle assembly 80. In a minimum configuration the nozzle assembly 80 may comprise a liquid inlet portion 110 having a liquid paint connector 100 for direct connection to an external paint cup 120 from which liquid paint can be supplied to the nozzle assembly 80 without using a hose or tube.

A screw aperture 190 in the gun body 180 serves to receive a screw with which an adapter according to the present disclosure can be attached to the gun body 180. The screw aperture 190 may previously have existed in the gun body 180 before conversion into an automatically-triggerable spray gun, or it may have been created in preparation of the conversion.

FIG. 4 is a sectional view of the gun body 180 of FIG. 3 after removal of the needle 20, the trigger 30, the needle adjustment control knob 60, the air valve and the other elements, and before attachment of an adapter according to the present disclosure. Compressed air enters through an air channel 45 and is divided into atomizing air and shaping air. Shaping air passes through a valve 75 that can be blocked by the shaping air control knob 70 and further through a shaping air duct 77 to the shaping air outlets 150 of the air cap 90. Not all parts of the shaping air duct are visible in FIG. 4.

Atomizing air flows through an atomizing air opening 85, that can be blocked or sealed by a poppet 300 of the adapter (explained below) according to the present disclosure, into an atomizing air duct 87 which conducts the atomizing air towards the nozzle 130, into an atomizing air path 169 in the air cap 90 and further to the center air outlet 170 in the vicinity of the nozzle 130, where it exits the air cap 90 and atomizes the liquid paint.

An elongated space 410 in the gun body 180 was occupied by the needle 20 of the hand-triggered spray gun 10, before removing the needle 20 in preparation for conversion to an automatically-triggerable spray gun 15.

At the rear of the atomizing air opening 85 (i.e. in a direction away from the nozzle 130) the gun body 180 forms an adapter receptacle 400 in which a portion of an adapter such as the first adapter 1 of FIG. 7 or the second adapter 2 of FIG. 8 can be received. Some of this space was previously occupied by the needle control knob 60, a spring and a portion of the original needle of the hand-triggered spray gun 10. These components were removed in preparation for converting the hand-triggered spray gun 10 into an automatically triggerable spray gun 15.

FIG. 5 is a sectional view of the atomizing air opening 85 of the gun body 180 of FIG. 4, and a poppet 300 of an adapter 1 according to the present disclosure. The poppet 300 is rotationally symmetric and has a frustoconical sealing surface 370 surrounding its front face 380. The poppet 300 is shown in its open position, in which atomizing air, coming from the air channel 45, can flow between the sealing surface 370 and a corresponding counter surface 390 of the atomizing air duct 87 of the gun body 180 into the atomizing air duct 87.

FIG. 6 is a further sectional view of the atomizing air opening 85 of the gun body 180 of FIGS. 4 and 5 and of the poppet 300, in which the poppet 300 is shown in its sealed position. The sealing surface 370 of the poppet 300 is in sealing contact with the counter surface 390. In this position atomizing air, coming from the air channel 45, is prevented from flowing between the sealing surface 370 and the counter surface 390 into the atomizing air duct 87.

FIG. 7 is a perspective view of a first adapter 1 according to the present disclosure. The adapter 1 has an elongated shape and comprises a radial thread 200, by which the adapter 1 can be attached to the gun body 180 of FIGS. 3 and 4. A screw can be pushed through a screw aperture 190 in the gun body 180 (see FIG. 3) and engage with the thread 200 to attach the adapter 1 to the gun body 180. The thread 200 is a connecting means 200 for attaching the adapter 1 to the gun body 180.

The adapter 1 further comprises a first energy supply connector 210 and a second energy supply connector 220 for connecting the adapter 1 to a supply of mechanical energy. In the embodiment of FIG. 7, the energy supply connectors 210, 220 are pressurized air connectors 210, 220 for connecting the adapter 1 to a supply of pressurized air. A supply of pressurized air is a supply of mechanical energy.

The adapter 1 further comprises a poppet actuator 230 that can be actuated automatically to move the poppet 300, in an actuation direction 420 relative to the energy supply connectors 210, 220, between a sealed position and an open position. The poppet actuator 230 uses mechanical energy received through the energy supply connectors 210, 220 to move the poppet 300. The actuation direction 420 is oriented parallel to the length direction of the elongated adapter 1. In the sealed position, once the adapter 1 is attached to the gun body 180 as shown in FIG. 11, the frustoconical sealing surface 370 cooperates with the counter surface 390 of the air duct 87 to seal the air duct 87 and blocks compressed air from entering the air duct 87, as is shown in FIG. 6.

The sealed position of the poppet 300 is the advanced position of the poppet 300, in which the poppet actuator 230 has pushed out the poppet 300 away from the energy supply connectors 210, 220 in the actuation direction 420. The open position of the poppet 300 is the rear position of the poppet 300, in which the poppet actuator 230 has retracted the poppet 300 in the actuation direction 420 towards the energy supply connectors 210, 220.

For converting the hand-triggered spray gun 10 of FIG. 1 into an automatically-triggerable spray gun 15 of FIG. 11, an insertion section 245 of the adapter 1 is inserted, up to a shoulder 240, into the adapter receptacle 400 of the gun body 180 of FIG. 4.

Once attached to the gun body 180, the first adapter 1 facilitates automatic management of atomizing air in the automatically-triggerable spray gun 15. A separate mechanism is required to automatically manage the position of a needle 20 relative to the nozzle 130 of the automatically-triggerable spray gun 15, and thereby adjust the amount of paint sprayed through the nozzle 130. In certain embodiments, however, the adapter comprises a needle that is connected to the poppet 300 suitably for the poppet actuator 230 to advance and retract the needle as it moves the poppet 300 between its sealed and its open position.

FIG. 8 illustrates such an embodiment of an adapter according to the present disclosure. This second adapter 2 is shown in a perspective view. The second adapter 2 is identical with the first adapter 1 of FIG. 7, except for an additional needle 21 which is attached to a second, slightly different poppet 301.

The second poppet 301 of the second adapter 2 comprises a frustoconical sealing surface 370, like the first poppet 300 of the first adapter 1. The poppet 301 is a two-part poppet 301 and comprises a recess and a spring (not visible) for spring-loading the needle 21. The second poppet 301 is shown in cross-section in FIG. 9.

For improved sealing, the sealing surface 370 is a surface of an elastomeric material which is allowed to deform slightly when pressed against the counter surface 390. It thereby helps prevent leaks by conforming to any irregularities in the counter surface 390.

FIG. 9 is a sectional view of the second poppet 301 and the needle 21 of the second adapter 2 of FIG. 8. The needle 21 is in contact with, and connected to the essentially rotationally-symmetric poppet 301 via a nailhead-shaped foot 25 of the needle 21, which is received in a cylindrical recess 320 of the poppet 301 and via a spring 330 arranged in the recess 320. Further to the frustoconical sealing surface 370, the poppet 301 has an elongated, rotationally symmetric, tubular front extension 315 forming a tubular passageway 310 to receive a portion of the needle 21 close to the needle foot 25. The needle 21 can move lengthwise in the poppet 301.

The outer surface of tubular front extension 315 can sealingly engage with a corresponding surface of the gun body 180 when the poppet 301 is in the retracted position. In some embodiments, there may be an actual seal installed in the gun body 180.

The second poppet 301 comprises, at its rear end, a fixation thread 340 to engage with a corresponding thread at the front end of an elongated rear extension element 290. The rear extension element 290 of stainless steel connects the poppet 301 to the poppet actuator 230, which is not shown in FIG. 9. The fixation thread 340 is arranged in the cylindrical recess 320 of the poppet 301. The rear extension element 290 and the poppet 301 are firmly connected with each other via the fixation thread 340 such that the spring 330 is slightly compressed between a support portion 295 of the rear extension element 290 and the needle foot 25, thereby urging the needle foot 25 away from the support portion 295. With the needle foot 25 arranged between the rear extension element 290 and the poppet 301, the needle foot 25 is connected securely to the poppet actuator 230.

In alternative embodiments, not shown in FIG. 9, the connection between the poppet 301 and the rear extension element 290 includes a sealing surface to prevent pressurized air from entering the recess 320 and escaping via passageway 310.

The second poppet 301 comprises a shoulder 350 between the passageway 310 and the recess 320 which can abut against the nailhead-shaped needle foot 25 for retracting the needle foot 25 and thereby retracting the needle 21 rearward.

The sealed position of the second poppet 301 is the advanced position of the poppet 301, in which the poppet actuator 230 has pushed out the poppet 301, via the rear extension element 290, away from the energy supply connectors 210, 220. The open position of the poppet 301 is the rear position of the poppet 301, in which the poppet actuator 230 has pulled back the poppet 301, via the rear extension element 290, towards the energy supply connectors 210, 220.

In referring to FIGS. 4-6, after attachment of the second adapter 2 to the gun body 180, when the poppet 301 is in the sealed position and the needle 21 is thereby fully advanced towards the nozzle 130 and the nozzle 130 is blocked, the sealing surface 370 of the poppet 301 sealingly contacts the counter surface 390 in the gun body 180 and seals the atomizing air duct 87. The sealing surface 370 thereby blocks compressed air from flowing towards and through the air cap 90 when the needle 21 is fully advanced.

Also in the second poppet 301 the sealing surface 370 is a surface of an elastomeric material which can deform slightly when pressed against the counter surface 390. It thereby helps prevent leaks by conforming to any irregularities in the counter surface 390 when the poppet 301 is in its sealed position.

Similarly, when the poppet 301 is in the fully open position and the needle 21 is thereby fully retracted away from the nozzle 130 and the nozzle 130 is open, the sealing surface 370 of the poppet 301 is not in contact with the counter surface 390 in the gun body 180 so that atomizing air can flow between the sealing surface 370 and the counter surface 390 into the atomizing air duct 87 and to the center air outlet 170 in the air cap 90. The poppet 301 thereby cooperates with the counter surface 390 such as to allow compressed air to enter the air duct 87. Bringing the poppet 301 into its open position has thus the double effect of starting the flow of atomizing air through the air duct 87 and of starting the flow of paint through the nozzle 130 by retracting the needle 21.

The poppet 301 is an individual, separate element. It is shaped such that it can be pushed over a compatible needle 21 such that the foot 25 of the needle 21 is received in the recess 320.

The spring 330 allows the needle foot 25 to move axially, against the spring force, within the recess 320. Before the second adapter 2 is attached to a gun body 180, the spring 330 pushes the needle 21 all the way forward, away from the rear extension element 290, until the needle foot 25 contacts the shoulder 350 of the poppet 301. This arrangement is illustrated in FIG. 9.

Once the second adapter 2 is inserted into the gun body 180 and attached to the gun body 180, the nozzle 130 is in contact with the needle tip 22 and forces the needle tip 22 backwards against the force of the spring 330, so that the needle foot 25 does not abut against the shoulder 350 of the poppet 301 anymore. The needle tip 22 still blocks the nozzle 130, and the sealing surface 370 of the poppet 301 still contacts the counter surface 390 in the gun body 180 and closes the air duct 87 so that no atomizing air flows and no paint is sprayed.

When the poppet actuator 230 initially automatically retracts the poppet 301 out of this sealed position by a small distance, the sealing surface 370 opens the air duct 87 in the gun body 180, so that compressed air, entering the automatically-triggerable paint spray gun 15 through the air connection 40, starts flowing through the air opening 85, the atomizing air duct 87 and the nozzle assembly 80 into the air cap 90 and through the center air outlet 170. The tip 22 of the needle 21, however, keeps being pressed against the nozzle 130 by the slightly expanding spring 330, thereby blocking the flow of paint. Hence, with an initial small retraction of the poppet 301, atomizing air flow sets in, but no paint is sprayed yet. This allows the atomizing air path of the automatically triggerable paint spray gun 15 to be cleared and ensures that there is a sufficient volume of atomizing air to atomize the paint and prevent large drips of unatomized paint from landing on the work piece.

As the poppet 301 is retracted further towards its fully-open position the shoulder 350 of the poppet 301 abuts against the needle foot 25 again. The needle 21 is therefore now retracted from the nozzle 130 by about the same distance by which the poppet 301 is further retracted. The needle tip 22 is thereby retracted from the nozzle 130 and gives way to a certain flow of liquid paint from the paint reservoir 120 into the nozzle assembly 80 and through the nozzle 130 to be sprayed. Atomizing air and paint are both flowing.

FIG. 10 illustrates in a perspective view the gun body 180 of FIG. 3 and the second adapter 2 of FIG. 9 before the front part of the adapter 2 is inserted into the gun body 180. The insertion direction is an axial direction 142, parallel to the actuation direction 420, parallel to the length direction 430 of the needle 21, and parallel to the spray axis 140.

FIG. 11 shows in a sketched sectional view of the second adapter 2 of FIG. 8 inserted into the gun body 180 of FIG. 3. The insertion section 245 is completely inserted into the adapter receptacle 400 and the adapter 2 is attached to the gun body 180 in a position in which the shoulder 240 abuts the border of the adapter receptacle 400, and the tip 22 of the needle 21 blocks the nozzle 130. The insertion of the adapter 2 into the adapter receptacle 400 and its subsequent attachment to the gun body 180 essentially completes the conversion of the previously hand-triggered spray gun 10 into an automatically-triggerable spray gun 15.

It can be seen from FIG. 11 that the poppet actuator 230, in this embodiment, comprises a piston 260 that is movable back and forth along the actuation direction 420 of the poppet 301 (which is a direction parallel to the spray axis 140) in a cylinder 270 by virtue of pressurized air supplied on either side of the piston 260 through the energy supply connectors 210, 220. When air pressure is higher in the pressurized air supply connected to the first supply connector 210 than in the pressurized air supply connected to the second supply connector 220, the piston 260 moves backward, i.e. away from the nozzle 130, into a retracted position. This brings the poppet 301 into its open position. Similarly, when air pressure is higher in the pressurized air supply connected to the second supply connector 220 than in the pressurized air supply connected to the first supply connector 210, the piston 260 moves forward, i.e. towards the nozzle 130, into an advanced position. This brings the poppet 301 into its sealed position. Depending on the precise control of pressurized air, intermediate positions of the piston 260 can be attained by moving the piston 260 by a pressure difference and holding it in the desired intermediate position by equal air pressure on both sides of the piston 260. FIG. 11 shows the piston 260 in its fully advanced position.

Respective desired air pressures on the first and the second air supply connectors 210, 220 can be obtained automatically, for example, by opening and closing, partially or completely, one or more automated, digitally-controlled valves in the respective pressurized air supply hoses connected to the first and the second air supply connectors 210, 220, or alternatively, for example, by operating automated, digitally-controlled air pumps supplying pressurized air at desired pressure levels into the first and the second air supply connectors 210, 220. The piston 260 can thereby be moved backward and forward in an automatic, digitally-controlled manner.

The piston 260 of the poppet actuator 230 is mechanically connected to the foot 25 of the needle 21 via the rear extension element 290 which extends along the spray axis 140. When the piston 260 moves into its fully retracted position, it pulls—via the rear extension element 290—the poppet 301 and the needle foot 25 with it and thereby retracts the needle 21 from the nozzle 130, which in use causes a maximum quantity of paint to be sprayed through the nozzle 130. Similarly, when the piston 260 moves into its fully advanced position, it moves—via the rear extension element 290—the poppet 301 and the needle foot 25 with it and thereby advances the needle 21 towards the nozzle 130 so that the needle tip 22 blocks the nozzle 130, which causes no more paint to be sprayed through the nozzle 130. An intermediate position of the piston 260 corresponds to a partial obstruction of the nozzle 130 by the needle tip 22 and a corresponding intermediate quantity of paint being sprayed through the nozzle 130. By automatically actuating the piston 260 of the poppet actuator 230 the needle 21 is retracted or advanced automatically, whereby the amount of paint sprayed is adjusted automatically.

1. Adapter for converting a hand-triggered paint spray gun into an automatically-triggerable paint spray gun, wherein the hand-triggered spray gun comprises a gun body comprising a nozzle through which liquid paint can be sprayed, a sealable air duct for conducting pressurized air towards the nozzle for atomization of the paint, and a counter surface for sealing the air duct;
the adapter comprising:
connecting means for attaching the adapter to the gun body;
an energy supply connector through which the adapter can receive mechanical or electrical energy;
a poppet actuator that can be actuated automatically using mechanical or electrical energy received through the energy supply connector,
a poppet, connected to the poppet actuator such that actuating the poppet actuator moves the poppet between a sealed position and an open position,
wherein, after attaching the adapter to the gun body, in the sealed position the poppet cooperates with the counter surface such as to block compressed air from entering the air duct, and wherein in the open position the poppet cooperates with the counter surface such as to allow compressed air to enter the air duct,
wherein the poppet comprises a sealing surface for sealingly contacting, when the poppet is in the sealed position, the counter surface of the air duct such as to block compressed air from entering the air duct.

2. The adapter according to claim 1, wherein the poppet is connected to the poppet actuator such that actuating the poppet actuator moves the poppet linearly in an actuation direction between the sealed position and the open position.

3. The adapter according to claim 1, wherein the sealing surface is frustoconical or comprises a frustoconical portion, or wherein the sealing surface is hemispherical or comprises a hemispherical portion.

4. The adapter according to claim 1, further comprising a needle, suitable for being arranged in the gun body such that a tip of the needle is arranged next to the nozzle such that, in use, retracting the needle from the nozzle causes more of the paint to be sprayed through the nozzle and that advancing the needle towards the nozzle causes less of the paint to be sprayed through the nozzle,
wherein the needle is mechanically connected to the poppet such that a movement of the poppet between the open position and the sealed position causes a movement of the needle.

5. The adapter according to claim 4, further comprising an elastic spring, wherein the needle is elongated to define a needle length direction, wherein the spring is arranged between a support portion of the poppet and a portion of the needle such as to facilitate a spring-loaded movement of the needle in the needle length direction relative to the poppet.

6. The adapter according to claim 1, wherein the poppet actuator comprises a piston, connected to the poppet and movable relative to the energy supply connector using mechanical or electrical energy received through the energy supply connector, such that movement of the piston moves the poppet between the sealed position and the open position.

7. An automatically-triggerable paint spray gun comprising:
a gun body comprising a nozzle through which liquid paint can be sprayed, a sealable air duct for conducting pressurized air towards the nozzle for atomization of the paint, and a counter surface for sealing the air duct,
an adapter according to claim 1, attached to the gun body using the connecting means such that the sealing surface of the poppet, in the sealed position, cooperates with the counter surface such as to block compressed air from entering the air duct, and such that, in the open position, the sealing surface cooperates with the counter surface such as to allow compressed air to enter the air duct.

8. The automatically-triggerable paint spray gun according to claim 7, wherein the sealing surface is hemispherical or comprises a hemispherical portion, and wherein the counter surface has a frustoconically shaped portion for sealingly contacting the sealing surface such as to block compressed air from entering the air duct when the poppet is in the sealed position.

9. The automatically-triggerable paint spray gun according to claim 7, wherein the spray gun can eject a jet of atomized paint along a spray axis,
wherein the poppet is connected to the poppet actuator such that actuating the poppet actuator moves the poppet linearly in an actuation direction between the sealed position and the open position, and wherein the adapter is arranged such that the actuation direction is parallel to the spray axis.

10. The automatically-triggerable paint spray gun according to claim 9, wherein the poppet is rotationally symmetric about a poppet axis, where the poppet axis is parallel to the actuation direction and wherein the poppet axis is collinear with the spray axis.

11. The automatically-triggerable paint spray gun according to claim 7,
wherein the gun body further comprises a nozzle assembly comprising the nozzle,
wherein the nozzle assembly further comprises a liquid inlet portion through which liquid paint can be supplied to the nozzle,
wherein the liquid inlet portion comprises an inlet connector for direct connection of a paint cup to the liquid inlet portion,
and optionally wherein the automatically-triggerable paint spray gun further comprises a paint cup for containing a liquid paint, connected directly to the liquid inlet portion via the inlet connector.

12. The automatically-triggerable paint spray gun according to claim 7,
further comprising a needle, wherein the needle is elongated to define a needle length direction, wherein the needle extends rearward, in the needle length direction, from a pointed tip to a needle foot,
wherein the needle is arranged in the gun body such that the tip is arranged next to the nozzle such that, in use, retracting the needle from the nozzle causes more of the paint to be sprayed through the nozzle and that advancing the needle towards the nozzle causes less of the paint to be sprayed through the nozzle,
and wherein the poppet actuator is arranged rearward, in the needle length direction, from the needle foot.

13. A process for converting a hand-triggered paint spray gun into an automatically triggerable paint spray gun, the process comprising:
providing a hand-triggered paint spray gun comprising:
a) a gun body comprising a nozzle through which liquid paint can be sprayed, a sealable air duct for conducting pressurized air towards the nozzle for atomization of the paint, a counter surface for sealing the air duct, and an atomizing air valve for cooperating with the counter surface such as to open or seal the air duct;
b) a trigger, mechanically connected to the atomizing air valve such that the atomizing air valve opens the air duct when the trigger is manually pulled,
providing an adapter according to claim 1;
removing the atomizing air valve;
attaching the adapter to the gun body using the connecting means such that the sealing surface of the poppet, in the sealed position, cooperates with the counter surface such as to block compressed air from entering the air duct, and such that, in the open position, the sealing surface cooperates with the counter surface such as to allow compressed air to enter the air duct.

14. The process according to claim 13, further comprising removing the trigger from the hand-triggered spray gun.

15. The process according to claim 13, wherein attaching the adapter to the gun body comprises inserting a portion of the adapter, such as an insertion section of the adapter, into the gun body.
